(19) United States
(12) Patent Application Publication
(10) Pub. No.: US 2025/0095035 A1
(43) Pub. Date: Mar. 20, 2025

(54) METHODS AND APPARATUS TO GENERATE CUSTOMIZED CUSTOMER MESSAGES

(71) Applicant: DIRECTV, LLC, El Segundo, CA (US)

(72) Inventors: Johnson Hao-Wen Kuan, Gardena, CA (US); Taylor Philip Hosbach, Easton, PA (US); Malav Hiren Shah, Frisco, TX (US); Usman Quddoos, Redondo Beach, CA (US)

(21) Appl. No.: 18/593,365

(22) Filed: Mar. 1, 2024

Related U.S. Application Data
(60) Provisional application No. 63/583,131, filed on Sep. 15, 2023.

(51) Int. Cl. G06Q 30/02; G06F 16/2455; G06F 40/186; G06F 40/40

(52) U.S. Cl. CPC G06Q 30/0281; G06F 16/2455; G06F 40/186; G06F 40/40

(57) ABSTRACT

Systems, apparatus, articles of manufacture, and methods to generate customized customer messages are disclosed. An example method includes selecting a prompt template based on an intended purpose of the customized customer message and a type of communication of the customized customer message, generating a prompt based on the customer data for an identified customer and the prompt template, providing the prompt to a large language model to cause generation of the customized customer message, and causing transmission of the customized customer message.

### FIELD OF THE DISCLOSURE

This disclosure relates generally to machine learning and, more particularly, to methods and apparatus to generate customized customer messages.

### BACKGROUND

Driving user engagement is a difficult task. Users, such as consumers of a good or a service, might not be aware of services and/or goods provided by an entity. Companies desire effective marketing tools that reach such users and, as a result, cause the user to interact with the entity (e.g., to purchase a good, to purchase a service, to request more information about product offerings, etc.).

### BRIEF DESCRIPTION OF THE DRAWINGS

FIG. 1 is a block diagram of an example environment in which an example consumer messaging platform operates to generate customized customer messages.

FIG. 2 is a flowchart representative of example machine readable instructions and/or example operations that may be executed, instantiated, and/or performed by example programmable circuitry to implement the customer messaging platform of FIG. 1 to generate a customized message for a customer.

FIG. 3 is a flowchart representative of example machine readable instructions and/or example operations that may be executed, instantiated, and/or performed by example programmable circuitry to implement the customer messaging platform of FIG. 1 to generate a customized message for a group of customers.

FIG. 4 is an example data table that may be stored in the example aggregated customer data datastore of FIG. 1.

FIG. 5 is an example structured query language (SQL) query that may be used by the example prompt generator circuitry of FIG. 1 to generate a prompt.

FIG. 6 is an example prompt that may be generated by the prompt generator circuitry of FIG. 1.

FIG. 7 is an example customer message that may be transmitted by the customer messaging platform of FIG. 1.

FIG. 8 is a flowchart representative of example machine readable instructions and/or example operations that may be executed, instantiated, and/or performed by example programmable circuitry to implement the customer messaging platform of FIG. 1 to generate a customized message for a customer.

FIG. 9 is a flowchart representative of example machine readable instructions and/or example operations that may be executed, instantiated, and/or performed by example programmable circuitry to implement the customer messaging platform of FIG. 1 to generate an embedding for use during creation of a customized message for a customer.

FIG. 10 is a block diagram of an example processing platform including programmable circuitry structured to execute, instantiate, and/or perform the example machine readable instructions and/or perform the example operations of FIGS. 2 and/or 3 to implement the customer messaging platform 110 of FIG. 1.

FIG. 11 is a block diagram of an example implementation of the programmable circuitry of FIG. 10.

FIG. 12 is a block diagram of another example implementation of the programmable circuitry of FIG. 10.

FIG. 13 is a block diagram of an example software/firmware/instructions distribution platform (e.g., one or more servers) to distribute software, instructions, and/or firmware (e.g., corresponding to the example machine readable instructions of FIGS. 2 and/or 3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Companies desire effective marketing tools that reach users and, as a result, cause the user to interact with the company (e.g., to purchase a good, to purchase a service, to request more information about product offerings, etc.). Mass marketing campaigns are frequently used to reach customers, but may sometimes be ineffective at driving engagement of particular customers because the customer, upon receipt of the message, may not feel that the message was intended for them. Instead, users may be more responsive to a customized message (e.g., a message that is personalized and/or directed specifically to that customer). However, creation of a customized message for each customer is a time-consuming task.

Examples disclosed herein utilize artificial intelligence for generation of customized customer messages. Artificial intelligence (AI), including machine learning (ML), deep learning (DL), Large Language Models (LLMs) and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, a Large Language Model (LLM) is used. Using an LLM enables customized messages to be generated. In general, machine learning models/architectures that are suitable to use in the example approaches disclosed herein will be transformer-type models, that receive one or more inputs, and generate a corresponding output (e.g., a textual message). However, other types of machine learning models could additionally or alternatively be used.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

Beyond initial training of a model, further training, sometimes referred to as fine-tuning may be performed. Fine-tuning involves taking an existing, pre-trained model, and further training the model on a smaller, task-specific dataset. An example goal of this process is to make the model adapt to the nuances and requirements of the target task while retaining the valuable knowledge and representations the model has acquired during the initial pre-trained training phase.

In other words, the pre-trained model typically serves as a starting point, providing a foundation of generalized knowledge that spans across various domains. For instance, in natural language processing, pre-trained language models (e.g., GPT-3) have already learned grammar, syntax, and world knowledge from extensive text corpora. Fine-tuning such pre-trained models builds upon this foundation by adjusting the model's weights and parameters based on the new, task-specific data.

To accomplish fine-tuning, a dataset that is specific to the task to be performed is used. This dataset contains examples or samples relevant to the task, often with associated labels or annotations. Thus, examples disclosed herein may utilize a model that has been fine-tuned using prior customer messages. In some examples, the prior customer messages may be annotated with labels to identify particular portions and/or features of the customer message. During fine-tuning, the model is trained to recognize patterns and features in the task-specific data, aligning the internal representations within the model to the requirements of the target task.

Fine-tuning may involve not only updating the model's weights but also adjusting hyperparameters like learning rates, batch sizes, and regularization techniques to ensure that the model converges effectively on the new task. Depending on the complexity of the task, architectural changes may also be made to the model, such as freezing certain layers, adding task-specific layers, or modifying the model structure. Fine-tuning is a powerful technique used in various domains, including natural language processing, computer vision, recommendation systems, and more, as it enables the adaptation of pre-trained models to solve specific real-world problems efficiently and effectively.

Once training is complete, the model is deployed for use as an executable construct that processes an input and provides an output. Such execution of the model is often referred to as an inference phase. In the inference phase, data to be analyzed (e.g., live data) is input to the model, and the model executes to create an output. This inference phase can be thought of as the AI “thinking” to generate the output based on what was learned from the training and/or fine-tuning (e.g., by executing the model to apply the learned patterns and/or associations to the live data). In some examples, input data undergoes pre-processing before being used as an input to the machine learning model. Moreover, in some examples, the output data may undergo post-processing after it is generated by the model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training (e.g., re-training, further fine-tuning, etc.) of an updated model can be triggered using the feedback and/or an updated training data set, hyperparameters, etc., to generate an updated, deployed model.

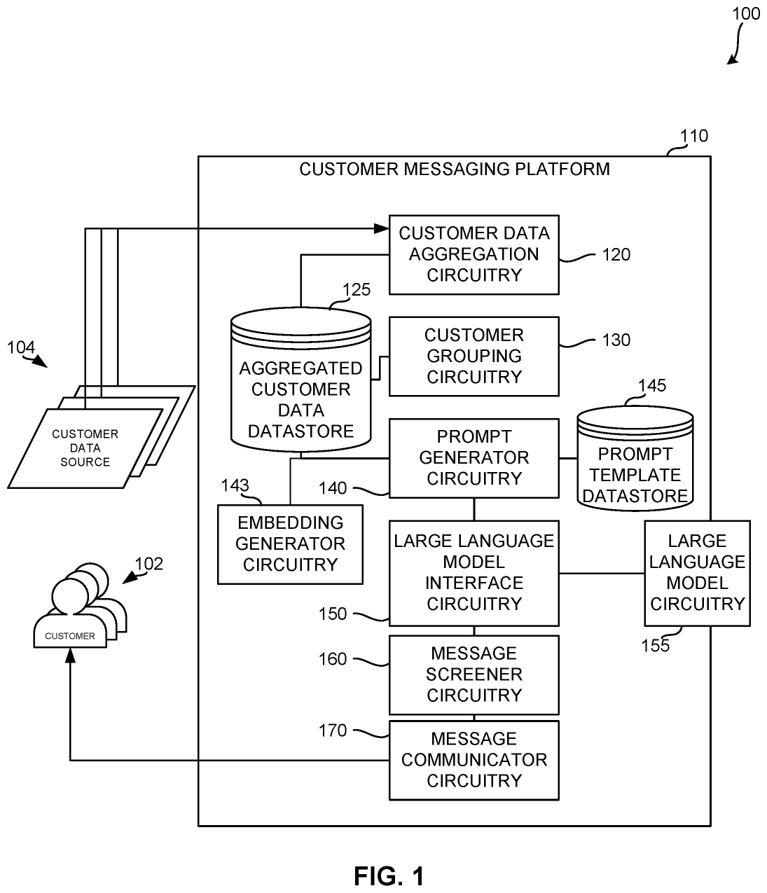

FIG. 1 is a block diagram of an example environment 100 in which customers 102 are messaged based on customer data source(s) 104 by an example consumer messaging platform 110. In examples disclosed herein, an entity operates the customer messaging platform 110 to aggregate customer data from the customer data source(s) 104, and provide customized messages to the customer(s) 102. In some examples, the message(s) provided to the customer(s) 102 may be for the purpose of driving customer engagement with the entity (e.g., to cause the customer 102 to purchase a good or service from the entity).

In examples disclosed herein, the entity operates the customer messaging platform 110. That is, the customer messaging platform 110 may be implemented by one or more servers operating at a facility owned by the entity. In this manner, the entity may desire to drive customer behavior and/or interaction with the entity. However, in some examples, the entity operating the customer messaging platform 110 is different from entity with which the message is intended to drive interaction. For example, a third party marketing entity may operate the customer messaging platform 110 on behalf of a retailer and/or service provider, with the intent of driving customer engagement/interaction with the retailer and/or service provider.

In examples disclosed herein, the customers 102 represent users that have purchased a good or service from an entity (e.g., the entity operating the customer messaging platform 110). However, such customers need not necessarily have purchased (e.g., previously purchased) such goods or services at the time of messaging by the customer messaging platform 110. That is, the customers may represent prospective (e.g., future), customers. While examples disclosed herein are described in the context of communicating with a customer, it should be understood that such customers may represent past customers, present customers, future customers, or, more generally, users (e.g., people) who are not (and may not become) customers.

The example customer data source(s) 104 of the illustrated example of FIG. 1 represent various sources of data that may be associated with a customer. Such data sources may represent databases of potential customers. Access to such databases may be obtained (e.g., rented, purchased, etc.), for the purpose of collecting such potential customer information. For example, the customer data may represent purchasing behavior of a customer, viewership history of the customer, web browsing behavior of the customer, demographic information of the customer, etc. For example, the customer data may indicate whether the customer has viewed a particular television channel in the last three days, the last seven days, the last thirty days, etc. The example customer messaging platform 110 of the illustrated example of FIG. 1 aggregates such customer information, and generates a message to the customer. The message to the customer may be for any purpose such as, for example, to drive customer engagement, for customer retention, for upselling a customer, etc.

The example customer messaging platform 110 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the customer messaging platform 110 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

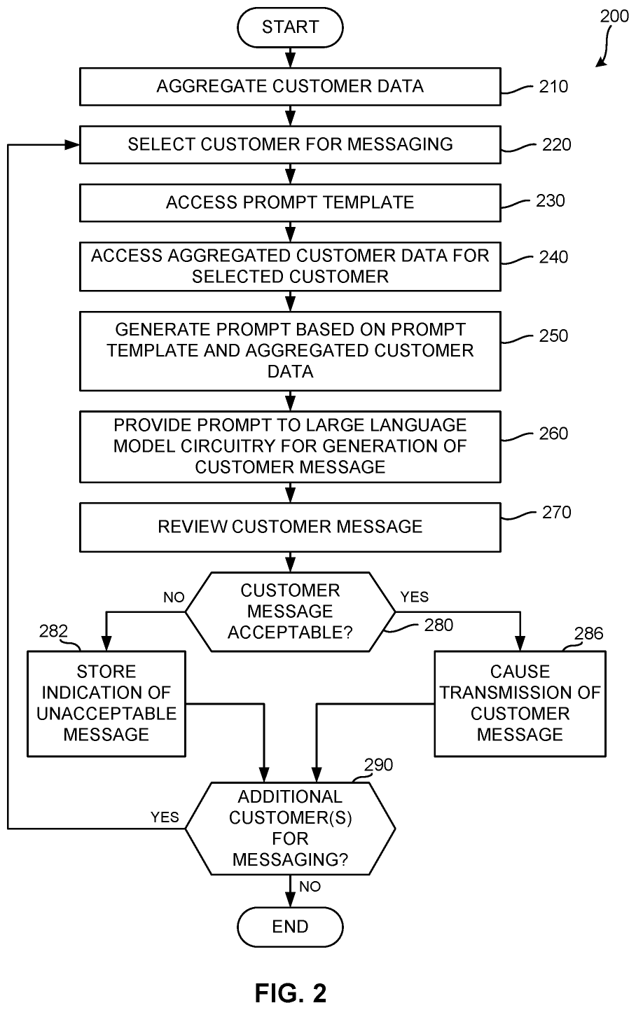

The example customer messaging platform 110 of the illustrated example of FIG. 1 includes customer data aggregation circuitry 120, an aggregated customer data datastore 125, customer grouping circuitry 130, prompt generator circuitry 140, embedding generator circuitry 143, a prompt template datastore 145, large language model interface circuitry 150, large language model circuitry 155, message screener circuitry 160, and message communicator circuitry 170. In some examples, the customer messaging platform 110 is instantiated by programmable circuitry executing customer messaging instructions and/or configured to perform operations such as those represented by the flowchart(s) of FIGS. 2 and/or 3.

The example customer data aggregation circuitry 120 of the illustrated example of FIG. 1 aggregates customer data from various customer data sources 104. Such customer data sources 104 may be sources operated by a same entity that operates the customer messaging platform 110. However, In some examples, the customer data sources 104 be operated by third parties that collect information about the customer or potential customer. The example customer data aggregation circuitry 120 collects and stored information from the customer data sources 104 and aggregates such information in the aggregated customer data datastore 125.

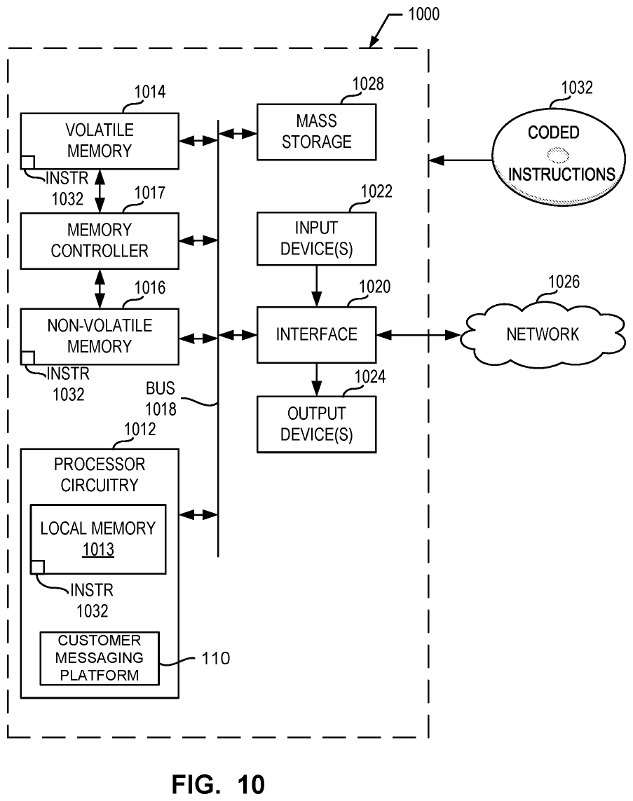

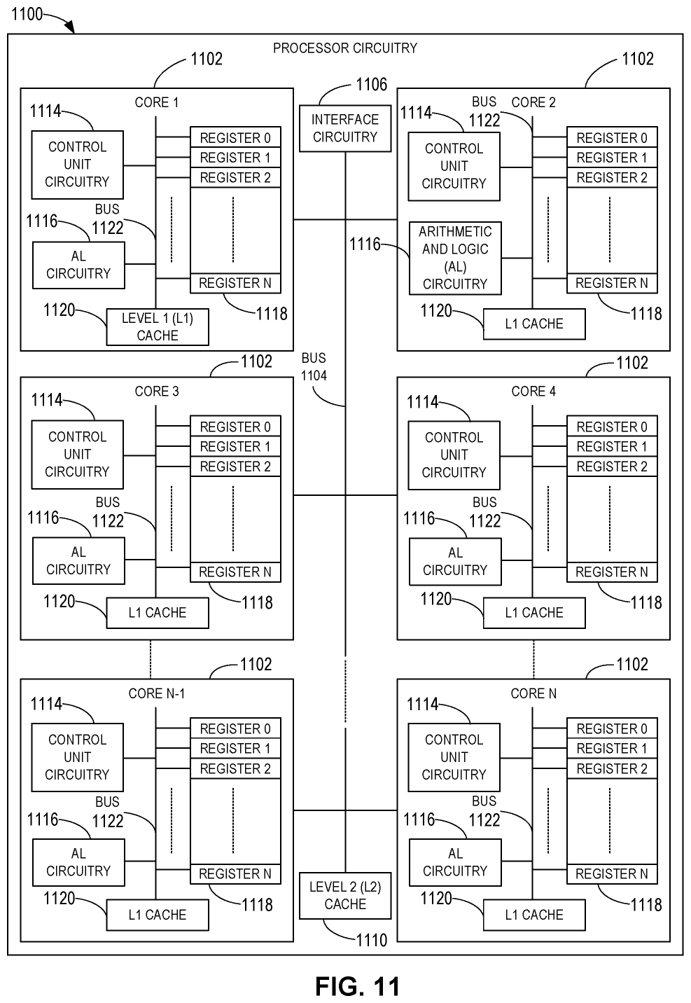

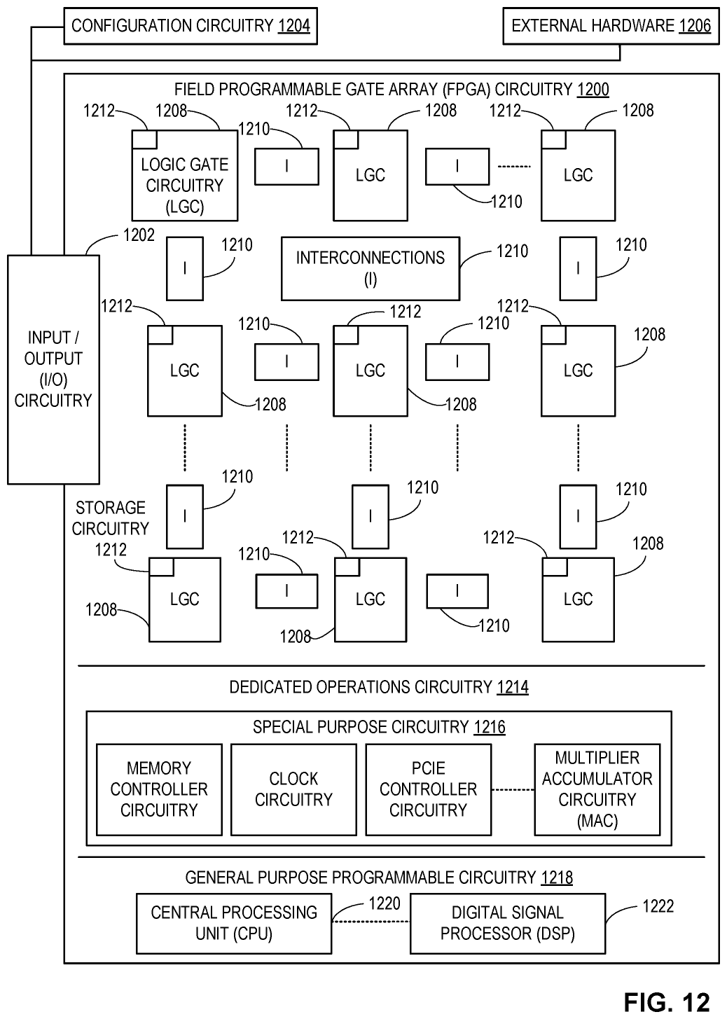

In some examples, the customer messaging platform 110 includes means aggregating. For example, the means for aggregating may be implemented by customer data aggregation circuitry 120. In some examples, the customer data aggregation circuitry 120 may be instantiated by programmable circuitry such as the example programmable circuitry 1012 of FIG. 10. For instance, the customer data aggregation circuitry 120 may be instantiated by the example microprocessor 1100 of FIG. 11 executing machine executable instructions such as those implemented by at least blocks 210, 310 of FIGS. 2 and/or 3. In some examples, the customer data aggregation circuitry 120 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the customer data aggregation circuitry 120 may be instantiated by any other combination of hardware, software, and/or firmware. For example, the customer data aggregation circuitry 120 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example aggregated customer data datastore 125 of the illustrated example of FIG. 1 stores the customer data aggregated by the example customer data aggregation circuitry 120. The example aggregated customer data datastore 125 of the illustrated example of FIG. 1 is implemented by any memory, storage device and/or storage disc for storing data such as, for example, flash memory, magnetic media, optical media, solid state memory, hard drive(s), thumb drive(s), etc. Furthermore, the data stored in the example aggregated customer data datastore 125 may be in any data format such as, for example, binary data, comma delimited data, tab delimited data, structured query language (SQL) structures, etc. While, in the illustrated example, the aggregated customer data datastore 125 is illustrated as a single device, the example aggregated customer data datastore 125 and/or any other data storage devices described herein may be implemented by any number and/or type(s) of memories.

The example customer grouping circuitry 130 of the illustrated example of FIG. 1 groups customers based on the data stored in the aggregated customer data datastore 125. In some examples, the customer grouping circuitry 130 executes a machine learning clustering algorithm (e.g., “K-Means”) to cluster the customers into micro-segments (e.g., find 1K micro-segments). However, any other clustering algorithm and/or technique may be used. For each of the micro-segments, the customer grouping circuitry 130 builds a profile.

In some examples, the profiles can be built using the centroid of the cluster or summarizing the attributes for each segment. For example, the personas may include, for example, “Big Leaguers” (e.g., users who watch sports programs), “Talking Heads” (e.g., users who watch news programs), “Drama Queens & Action Heroes” (e.g., users who watch drama programming), “Reality Stars” (e.g., users who watch reality television shows), “Everybody loves sitcoms” (e.g., users who watch sitcoms), “Political News Junkies” (e.g., users who watch political news shows), “Documentarians” (e.g., users who watch documentary shows), “The Brady Bunch” (e.g., users who watch family programming), “Country club members” (e.g., users who watch golf programming), and “Romantics” (e.g., users who watch romantic programming). While the example personas presented above include ten personas, such clustering performed by the customer grouping circuitry 130 may identify any number of personas (e.g., groups, segments, divisions, etc.). For example, the customer grouping circuitry 130 may identify one hundred personas, one thousand personas, etc.

Subsequent to generation of the profiles, such profiles (and/or information associated with characterizing such profiles) can be utilized in the prompt that is provided to the LLM for generation of the personalized message.

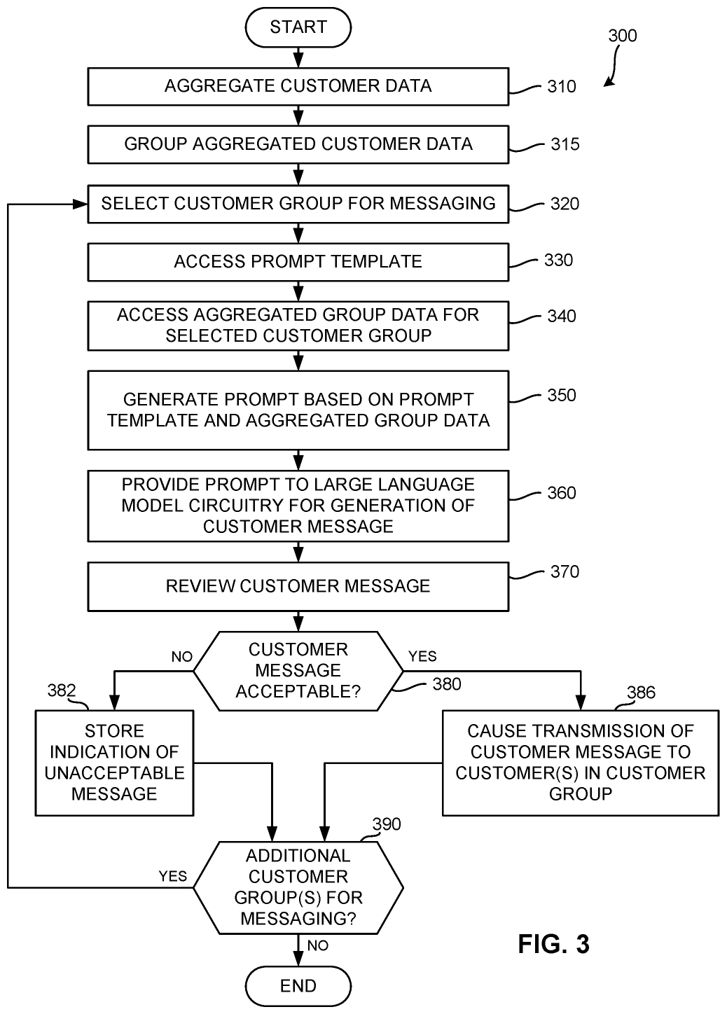

In some examples, the customer messaging platform 110 includes means for grouping. For example, the means for grouping may be implemented by customer grouping circuitry 130. In some examples, the customer grouping circuitry 130 may be instantiated by programmable circuitry such as the example programmable circuitry 1012 of FIG. 10. For instance, the customer grouping circuitry 130 may be instantiated by the example microprocessor 1100 of FIG. 11 executing machine executable instructions such as those implemented by at least blocks 315 of FIG. 3. In some examples, the customer grouping circuitry 130 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the customer grouping circuitry 130 may be instantiated by any other combination of hardware, software, and/or firmware. For example, the customer grouping circuitry 130 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

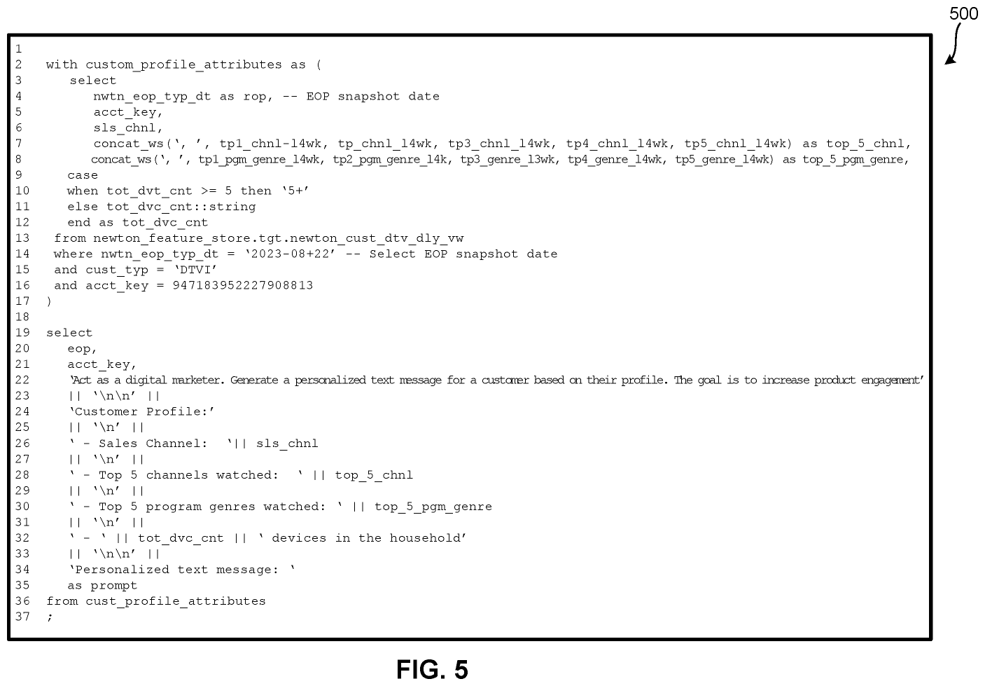

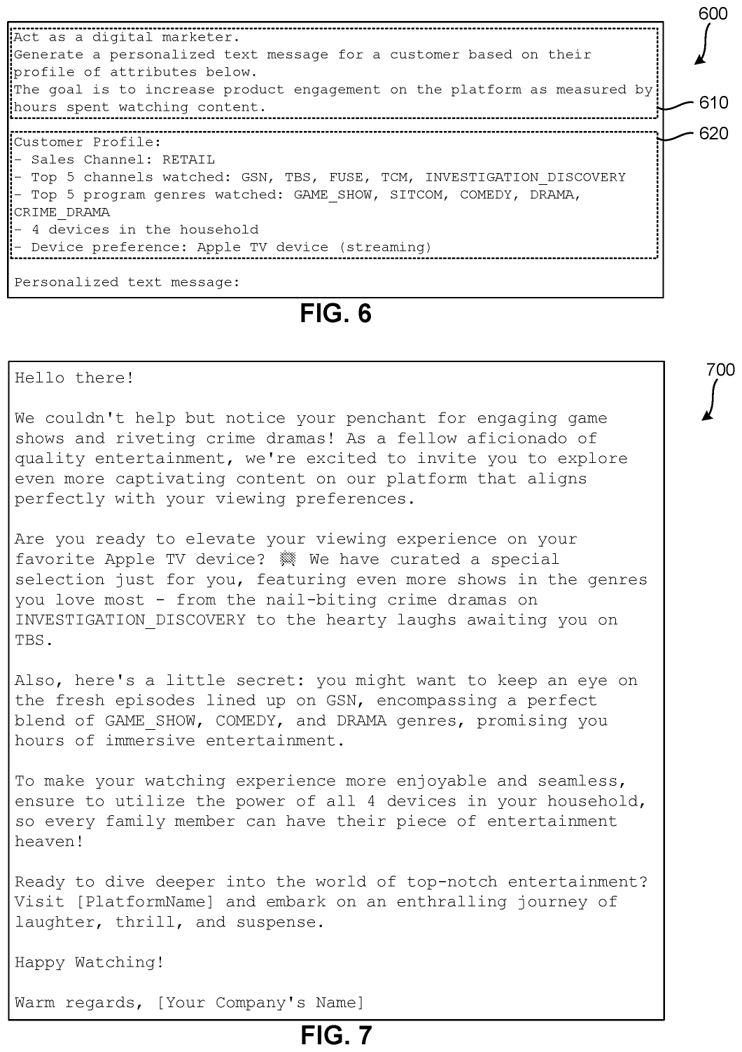

The example prompt generator circuitry 140 of the illustrated example of FIG. 1 obtains data specific to the customer (or group of customers) for which a customized message is to be generated. The example prompt generator circuitry 140 utilizes a structured query language (SQL) query based on a prompt template (stored in the prompt template datastore 145) to generate the prompt. An example SQL query is illustrated below in connection with FIG. 5. An example resultant prompt is illustrated below in connection with FIG. 6. In some examples, the example prompt generator circuitry 140 interacts with the example embedding generator circuitry 143 to generate an embedding for use in association with a generated prompt. Thus, while in some examples, the prompt generated by the example prompt generator circuitry 140 may include customer information, in other examples, the prompt might not include such customer information, and the customer information may be encoded into an embedding that is used as a context for the prompt.

In some examples, the customer messaging platform 110 includes means for generating. For example, the means for generating may be implemented by prompt generator circuitry 140. In some examples, the prompt generator circuitry 140 may be instantiated by programmable circuitry such as the example programmable circuitry 1012 of FIG. 10. For instance, the prompt generator circuitry 140 may be instantiated by the example microprocessor 1100 of FIG. 11 executing machine executable instructions such as those implemented by at least blocks 220, 230, 240, 250, 320, 330, 340, 350 of FIGS. 2 and/or 3. In some examples, the prompt generator circuitry 140 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the prompt generator circuitry 140 may be instantiated by any other combination of hardware, software, and/or firmware. For example, the prompt generator circuitry 140 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example embedding generator circuitry 143 of the illustrated example of FIG. 1 generates an embedding that may be used in association with a prompt provided to the LLM circuitry 155. In some examples, the embedding is created using a Sparse Ordered Random Chops (SpORC) technique. Utilizing such a technique, the example embedding generator circuitry 143 generates an embedding that is based on non-null and non-empty data columns that are ordered based their importance. In examples disclosed herein, a defined ordering of importance of fields is stored in the aggregated customer data datastore 125. Such ordering may be generated by business domain experts. Columns of lesser importance are then randomly removed from a listing of columns, and this reduced listing of columns is used to create an embedding. This process may be repeated multiple times by the embedding generator circuitry 143 to generate an embedding that more closely exemplifies the data had columns not been removed. In this manner, an embedding having a reduced size is created which may then be provided to the LLM circuitry 155 as a context for the creation of a customer message in response to a prompt. Using such an embedding may, in some examples, reduce a number of tokens being operated upon by the LLM circuitry 155, thereby increasing efficiency of the LLM circuitry 155.

While example approaches disclosed herein are described in the context of data being stored in a column, such a column-based data structure (e.g., data stored in rows and columns) need not necessarily be used. Instead, any type of data structure may additionally or alternatively be used. For example, such data may be stored as fields, attributes, parameters, metadata, facets, etc.

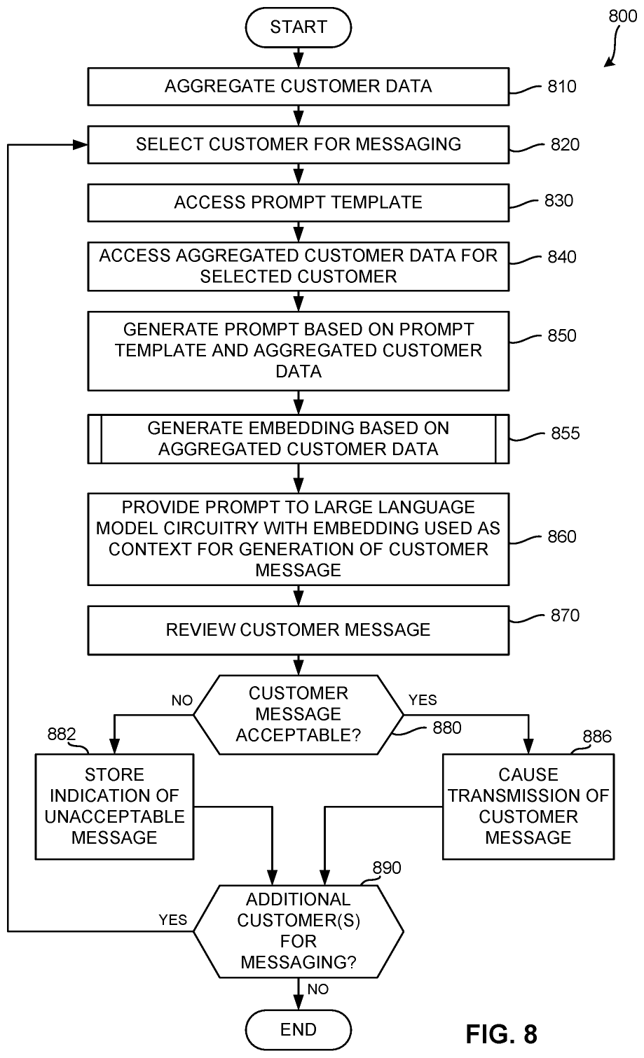

In some examples, the customer messaging platform 110 includes means for generating an embedding. For example, the means for generating an embedding may be implemented by embedding generator circuitry 143. In some examples, the embedding generator circuitry 143 may be instantiated by programmable circuitry such as the example programmable circuitry 1012 of FIG. 10. For instance, the prompt generator circuitry 140 may be instantiated by the example microprocessor 1100 of FIG. 11 executing machine executable instructions such as those implemented by at least blocks 855, 910, 920, 930, 940, 950, 960, 970, 980 of FIGS. 8 and/or 9. In some examples, the embedding generator circuitry 143 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the embedding generator circuitry 143 may be instantiated by any other combination of hardware, software, and/or firmware. For example, the embedding generator circuitry 143 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example prompt template datastore 145 of the illustrated example of FIG. 1 stores one or more prompt templates that are used by the prompt generator circuitry 140 for generation of a prompt.

The example prompt template datastore 145 of the illustrated example of FIG. 1 is implemented by any memory, storage device and/or storage disc for storing data such as, for example, flash memory, magnetic media, optical media, solid state memory, hard drive(s), thumb drive(s), etc.

Furthermore, the data stored in the example prompt template datastore 145 may be in any data format such as, for example, binary data, comma delimited data, tab delimited data, structured query language (SQL) structures, etc. While, in the illustrated example, the prompt template datastore 145 is illustrated as a single device, the example prompt template datastore 145 and/or any other data storage devices described herein may be implemented by any number and/or type(s) of memories.

The example large language model interface circuitry 150 of the illustrated example of FIG. 1 receives the prompt generated by the prompt generator circuitry 140 and provides the prompt to the large language model circuitry 155. The example large language model interface circuitry 150 receives a response from the large language model circuitry 155 including the customized message. An example message is illustrated below in connection with FIG. 7.

In some examples, the customer messaging platform 110 includes means for interfacing. For example, the means for interfacing may be implemented by large language model interface circuitry 150. In some examples, the large language model interface circuitry 150 may be instantiated by programmable circuitry such as the example programmable circuitry 1012 of FIG. 10. For instance, the large language model interface circuitry 150 may be instantiated by the example microprocessor 1100 of FIG. 11 executing machine executable instructions such as those implemented by at least blocks 260, 360 of FIGS. 2 and/or 3. In some examples, the large language model interface circuitry 150 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the large language model interface circuitry 150 may be instantiated by any other combination of hardware, software, and/or firmware. For example, the large language model interface circuitry 150 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example large language model circuitry 155 of the illustrated example of FIG. 1 executes a large language model to transform an input prompt into an output message. A large language model (LLM) operates by utilizing a neural network architecture known as a Transformer. LLMs are designed to understand and generate human-like text based on the vast amount of data on which the LLM has been trained.

In the illustrated example of FIG. 1, the LLM circuitry 155 is illustrated at the edge of the customer messaging platform 110 to represent that the large language model circuitry 155 may be executed/implemented either locally to the customer messaging platform 110 or at a computing system remote from the customer messaging platform 110. For example, large language models may be executed in a cloud setting (e.g., remotely from the customer messaging platform 110). Remote execution offers some advantages including, for example, that the LLM can be accessed from anywhere, providing scalability and ease of use. Cloud-based models are usually more powerful than locally-executed models, as cloud-based models typically leverage high-performance hardware and are continuously updated with the latest improvements and fine-tuning. However, cloud-based models may raise concerns about data privacy, latency, and cost, as entities typically pay for the computational resources they consume (e.g., entities pay for use of the cloud-based model).

On the other hand, executing large language models locally provides an entity with more control over their data, and potentially lower latency for inference. Local execution can also work offline, which is beneficial in scenarios with limited Internet access or where data privacy is important. However, local execution typically requires powerful hardware, significant storage, and regular updates to maintain model performance.

In some examples, the customer messaging platform 110 includes means for inferring. For example, the means for inferring may be implemented by LLM circuitry 155. In some examples, the LLM circuitry 155 may be instantiated by programmable circuitry such as the example programmable circuitry 1012 of FIG. 10. In some examples, LLM circuitry 155 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the LLM circuitry 155 may be instantiated by any other combination of hardware, software, and/or firmware. For example, the LLM circuitry 155 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example message screener circuitry 160 of the illustrated example of FIG. 1 reviews the message returned to the large language model interface circuitry 150 to determine (e.g., validate, confirm) if the message is acceptable for sending to a customer. In some examples, the message screener circuitry 160 augments the message by replacing tokens and/or other variables included in the message with user-friendly terms. For example, in the example message illustrated in FIG. 7, the term [PlatformName] may be replaced with a user-understandable name of a platform, and [Your Company's Name] may be replaced with a name of a company.

In some examples, the message screener circuitry 160 may utilize the large language model interface circuitry 150 to analyze the message to determine whether the message includes any profanity, any protected customer information (e.g., telephone numbers, personally identifiable information (PII), payment information, etc.) that should not be used when communicating with a customer, or any tokens and/or other variables to be replaced before sending to a customer. If the message is not acceptable, the message screener circuitry 160 stores an indication of the unacceptable message (e.g., so that the message may be later reviewed by an administrator). If the message is acceptable, the message is provided to the message communicator circuitry 170.

In some examples, the customer messaging platform 110 includes means for screening. For example, the means for screening may be implemented by message screener circuitry 160. In some examples, the message screener circuitry 160 may be instantiated by programmable circuitry such as the example programmable circuitry 1012 of FIG. 10. For instance, the message screener circuitry 160 may be instantiated by the example microprocessor 1100 of FIG. 11 executing machine executable instructions such as those implemented by at least blocks 270, 280, 282, 370, 380, 382 of FIGS. 2 and/or 3. In some examples, the message screener circuitry 160 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the message screener circuitry 160 may be instantiated by any other combination of hardware, software, and/or firmware. For example, the message screener circuitry 160 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example message communicator circuitry 170 of the illustrated example of FIG. 1 transmits the message to the customer 102. In examples disclosed herein, any different messaging medium may be used to communicate the message to the customer 102. For example, the message may be an email message, a short message service message, a push notification, an “in-app” notification, etc. The desired messaging type may direct the generation of the message. For example, whereas the example message of FIG. 7 is appropriate for use in an email message to a customer, there may be too much text for inclusion in a SMS message and/or push notification. In some examples, an indication of the type of requested output is included in the prompt template.

In some examples, the customer messaging platform 110 includes means for communicating. For example, the means for communicating may be implemented by message communicator circuitry 170. In some examples, the message communicator circuitry 170 may be instantiated by programmable circuitry such as the example programmable circuitry 1012 of FIG. 10. For instance, the message communicator circuitry 170 may be instantiated by the example microprocessor 1100 of FIG. 11 executing machine executable instructions such as those implemented by at least blocks 286, 386 of FIGS. 2 and/or 3. In some examples, the message communicator circuitry 170 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the message communicator circuitry 170 may be instantiated by any other combination of hardware, software, and/or firmware. For example, the message communicator circuitry 170 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the customer messaging platform 110 of FIG. 1 is illustrated in FIG. 1, one or more of the elements, processes, and/or devices illustrated in FIG. 1 may be combined, divided, re-arranged, omitted, eliminated, and/or implemented in any other way. Further, the example customer data aggregation circuitry 120, the example customer grouping circuitry 130, the example prompt generator circuitry 140, the example embedding generator circuitry 140, the example large language model interface circuitry 150, the example large language model circuitry 155, the example message screener circuitry 160, the example message communicator circuitry 170, and/or, more generally, the example customer messaging platform 110 of FIG. 1, may be implemented by hardware alone or by hardware in combination with software and/or firmware. Thus, for example, any of the example customer data aggregation circuitry 120, the example customer grouping circuitry 130, the example prompt generator circuitry 140, the example embedding generator circuitry 140, the example large language model interface circuitry 150, the example large language model circuitry 155, the example message screener circuitry 160, the example message communicator circuitry 170, and/or, more generally, the example customer messaging platform 110, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example customer messaging platform 110 of FIG. 1 may include one or more elements, processes, and/or devices in addition to, or instead of, those illustrated in FIG. 1, and/or may include more than one of any or all of the illustrated elements, processes and devices.

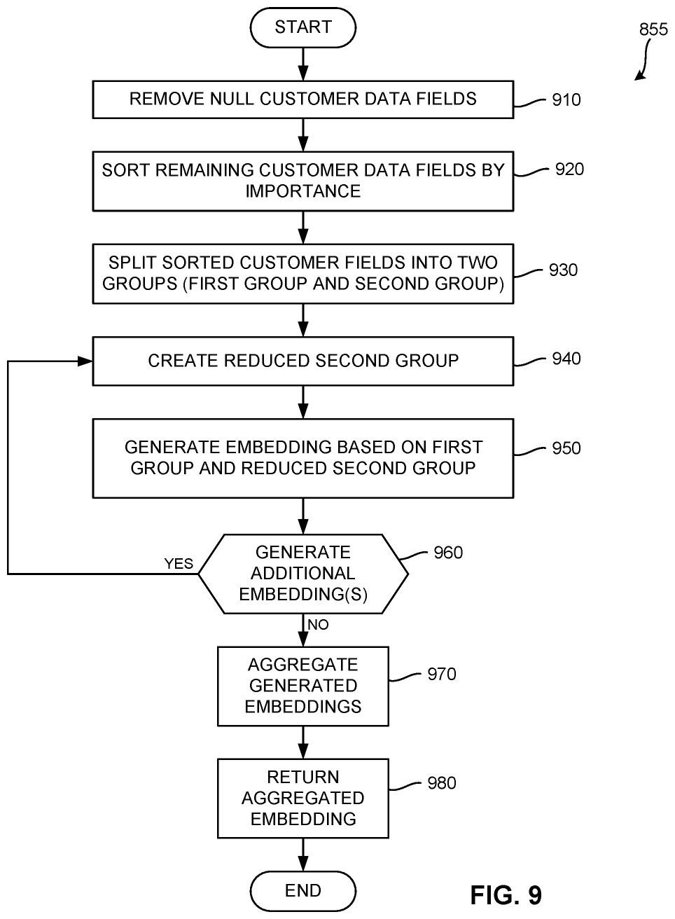

Flowchart(s) representative of example machine readable instructions, which may be executed by programmable circuitry to implement and/or instantiate the customer messaging platform 110 of FIG. 1 and/or representative of example operations which may be performed by programmable circuitry to implement and/or instantiate the customer messaging platform 110 of FIG. 1, are shown in FIGS. 2 and/or 3. The machine readable instructions may be one or more executable programs or portion(s) of one or more executable programs for execution by programmable circuitry such as the programmable circuitry 1012 shown in the example processor platform 1000 discussed below in connection with FIG. 10 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 2 and/or 3, many other methods of implementing the example customer messaging platform 110 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 2 and/or 3 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 2 is a flowchart representative of example machine readable instructions and/or example operations 200 that may be executed, instantiated, and/or performed by example programmable circuitry to implement the customer messaging platform 110 of FIG. 1 to generate a customized message for a customer. The example machine-readable instructions and/or the example operations 200 of FIG. 2 begins with the customer data aggregation circuitry 120 aggregating the customer data. (Block 210). The aggregated customer data is then stored in the aggregated customer data datastore 125. The example prompt generator circuitry 140 selects a customer for messaging. (Block 220). The example prompt generator circuitry 140 accesses a template for use in generating the prompt from the prompt template datastore 145. (Block 230). The example prompt template may be selected based on, for example, an intended purpose of the message and/or the intended communication medium. For example, separate templates may be stored for generation of email messages for engagement, email messages for retention, email messages for upselling, SMS messages for engagement, SMS messages for retention, SMS messages for upselling, push messages for engagement, push messages for retention, push messages for upselling, etc. In other words, various templates may be used for combinations of the type of communication medium and the intended purpose of the message.

The example prompt generator circuitry 140 accesses the aggregated customer data for the selected customer. (Block 240). The example prompt generator circuitry 140 then generates a prompt based on the prompt template and the aggregated customer data. (Block 250). The example large language model interface circuitry 150 provides the prompt to the large language model circuitry for generation of a customer message. (Block 260). The example large language model circuitry 155 then generates the customer message and returns the same to the large language model interface circuitry 150.

The example message screener circuitry 160 reviews the message to determine whether the message is acceptable. (Block 270). For example, the message screener circuitry 160 analyzes the message to determine whether the message includes any profanity, any protected customer information (e.g., telephone numbers, personally identifiable information (PII), payment information, etc.) that should not be used when communicating with a customer, or any tokens and/or other variables to be replaced before sending to a customer. If the message is not acceptable (e.g., block 280 returns a result of NO), the message screener circuitry 160 stores an indication of the unacceptable message (e.g., so that the message may be later reviewed by an administrator). (Block 282). If the message is acceptable, the message communicator circuitry 170 causes transmission of the customer message. (Block 286).

The example prompt generator circuitry 140 then determines if there is an additional customer for messaging. (Block 290). If there is an additional customer for messaging (e.g., block 290 returns a result of YES), control proceeds to block 220, where the customer is identified and the message generation process repeats for the identified customer. The example process continues until no further customers are identified for messaging (e.g., until block 290 returns a result of NO). In this manner, customized messages may be generated and transmitted for many different customers. For example, messages may be generated and sent to hundreds, thousands, or even millions of customers, with each of the messages being tailored specifically to the customer to which the message is sent. The example process of FIG. 2 then terminates, but may be repeated periodically (e.g., every week, every month, etc.) and/or a-periodically (e.g., at the request of an administrator).

FIG. 3 is a flowchart representative of example machine readable instructions and/or example operations that may be executed, instantiated, and/or performed by example programmable circuitry to implement the customer messaging platform 110 of FIG. 1 to generate a customized message for a group of customers. In contrast to the example process of FIG. 2, in the illustrated example of FIG. 3, customers are first grouped by the example customer grouping circuitry 130. While providing individualized messages to each customer is beneficial, many customers may be very similar to one another. As a result, the resultant messages for two similar customers may be similar as well. To reduce computational burden on the large language model circuitry 155, which would otherwise repetitively generate similar messages for similar customers, by first grouping customers into personas, the number of requests for generation of a message to the large language model circuitry 155 can be reduced.

The example machine-readable instructions and/or the example operations 300 of FIG. 3 begins with the customer data aggregation circuitry 120 aggregating the customer data. (Block 310). The aggregated customer data is then stored in the aggregated customer data datastore 125.

The example customer grouping circuitry 130 groups customers in the aggregated customer data datastore. (Block 315). In some examples, the customer grouping circuitry 130 executes a machine learning clustering algorithm (e.g., “K-Means”) to cluster the customers into micro-segments (e.g., find 1K micro-segments). However, any other clustering algorithm and/or technique may be used. For each of the micro-segments, the customer grouping circuitry 130 builds a profile. In some examples, the profiles can be built using the centroid of the cluster or summarizing the attributes for each micro-segment.

The example prompt generator circuitry 140 selects a customer group for messaging. (Block 320). The example prompt generator circuitry 140 accesses a template for use in generating the prompt from the prompt template datastore 145. (Block 330). The example prompt template may be selected based on, for example, an intended purpose of the message and/or the intended communication medium. For example, separate templates may be stored for generation of email messages for engagement, email messages for retention, email messages for upselling, SMS messages for engagement, SMS messages for retention, SMS messages for upselling, push messages for engagement, push messages for retention, push messages for upselling, etc. In other words, various templates may be used for combinations of the type of communication medium and the intended purpose of the message.

The example prompt generator circuitry 140 accesses aggregated group data (e.g., the profile) for the selected customer group. (Block 340). The example prompt generator circuitry 140 then generates a prompt based on the prompt template and the aggregated group data. (Block 350). The example large language model interface circuitry 150 provides the prompt to the large language model circuitry for generation of a customer message. (Block 360). The example large language model circuitry 155 then generates the customer message and returns the same to the large language model interface circuitry 150.

The example message screener circuitry 160 reviews the message to determine whether the message is acceptable. (Block 370). For example, the message screener circuitry 160 analyzes the message to determine whether the message includes any profanity, any protected customer information (e.g., telephone numbers, personally identifiable information (PII), payment information, etc.) that should not be used when communicating with a customer, or any tokens and/or other variables to be replaced before sending to a customer. If the message is not acceptable (e.g., block 380 returns a result of NO), the message screener circuitry 160 stores an indication of the unacceptable message (e.g., so that the message may be later reviewed by an administrator). (Block 382). If the message is acceptable, the message communicator circuitry 170 causes transmission of the customer message to the customers in the customer group. (Block 386).

The example prompt generator circuitry 140 then determines if there is an additional customer group for messaging. (Block 390). If there is an additional customer group for messaging (e.g., block 390 returns a result of YES), control proceeds to block 320, where the customer group is identified and the message generation process repeats for the identified customer group. The example process continues until no further customer group(s) are identified for messaging (e.g., until block 390 returns a result of NO). In this manner, customized messages may be generated and transmitted for many different customer group(s). The example process of FIG. 3 then terminates, but may be repeated periodically (e.g., every week, every month, etc.) and/or a-periodically (e.g., at the request of an administrator).

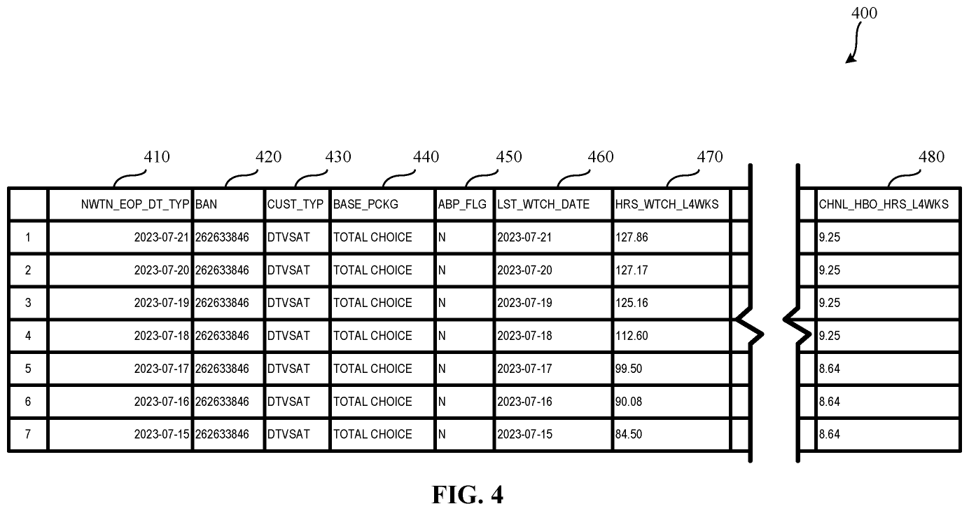

FIG. 4 is an example data table that may be stored in the example aggregated customer data datastore 125 of FIG. 1. The example data table includes columns identifying a date 410, a customer identifier 420, a customer type 430, a base package used by the customer 440, whether the customer is enrolled in auto-bill pay 450, a timestamp representing when the user last watch a television program 460, a number of total hours watched in the last four weeks 470, a number of hours watched of a particular channel (e.g., HBO) in the last four weeks 480.

In the illustrated example of FIG. 4, a total of eight columns are shown. However, in practice, many more columns representing many different attributes of a customer may be used. For example, the aggregated customer data datastore 125 may include eight hundred attributes of a customer, one thousand attributes of a customer, ten thousand attributes of a customer. Various different attributes may be selected for use in a prompt based on, for example, the purpose of the prompt. For example, a prompt that is intended to generate a message to entice a customer to sign up for auto-bill pay may utilize payment history information for the customer, whereas a prompt intended to generate a message related to an upcoming new channel offering might not utilize the payment history information.

As noted above, many different attributes may be used. Such attributes may include browsing history of the customer, whether particular services and/or goods have been purchased by the customer, work performed for the customer, a tenure of the customer (e.g., how long the customer has been a customer), viewership history (e.g., how long the customer has viewed a particular channel and/or type of channel, how long the customer has used a particular type of device to view media), hardware identifiers and/or types of hardware utilized by the customer (e.g., streaming television devices, televisions, tablet devices, mobile devices, personal computers, etc.), etc.

FIG. 5 is an example structured query language (SQL) query 500 that may be used by the example prompt generator circuitry 140 of FIG. 1 to generate a prompt. In some examples, the prompt template may be implemented by such a SQL query. As a result of executing the SQL query, the prompt generator 140 obtains a resultant prompt. An example prompt is described below in connection with FIG. 6. In the illustrated example of FIG. 5, attributes including a sales channel, a list of the top five channels watched, a list of the top five genres watched, and a number of devices in the household are used for generating the prompt. However, any other attributes may additionally or alternatively be used based on, for example, the intended purpose of the prompt and/or resultant message. Moreover, different templates may be utilized to achieve different purposes. For example, a description of the purpose of the template may be included in the prompt (e.g., to increase product engagement, to retain customers, upselling, increase sales, etc.). In some examples, the purpose may be to cause a customer to increase sales to non-customers (e.g., to generate a “tell your friends” message).

FIG. 6 is an example prompt 600 that may be generated by the prompt generator circuitry 140 of FIG. 1. The example prompt 600 of FIG. 6 is generated by the prompt generator circuitry 140 based on execution of the example SQL query 500 of FIG. 5. In the illustrated example of FIG. 6, the prompt 600 includes a first portion 610, that defines what the LLM circuitry 155 is being asked to create. The prompt 600 also includes a second portion 620 that includes customer profile information (e.g., information specific to the customer(s) to which the resulting message is to be provided).

FIG. 7 is an example customer message 700 that may be generated for transmission to customer. The example customer message 700 represents an output of the LLM circuitry 155. In the illustrated example of FIG. 7, the message is a textual message, but may include graphical elements. Such graphical elements may be emojis and/or other characters. Additionally or alternatively, the message may be generated using HyperText Markup Language (HTML), which may be useful when sending the message via email. Of course, other types of markup languages may additionally or alternatively be used.

FIG. 8 is a flowchart representative of example machine readable instructions and/or example operations that may be executed, instantiated, and/or performed by example programmable circuitry to implement the customer messaging platform of FIG. 1 to generate a customized message for a customer. In the illustrated example of FIG. 8, as compared to the examples of FIGS. 2 and/or 3, customer data is aggregated into an embedding that is used as a context for the prompt provided to the LLM. The illustrated example of FIG. 8 is explained in the context of customer data representing a particular customer (e.g., the example approach of FIG. 2), however, customer segmentation and/or aggregation may additionally or alternatively be utilized (as is shown in the example approach of FIG. 3).

The example machine-readable instructions and/or the example operations 800 of FIG. 8 begins with the customer data aggregation circuitry 120 aggregating the customer data. (Block 810). The aggregated customer data is then stored in the aggregated customer data datastore 125. The example prompt generator circuitry 140 selects a customer for messaging. (Block 820). The example prompt generator circuitry 140 accesses a template for use in generating the prompt from the prompt template datastore 145. (Block 830). The example prompt template may be selected based on, for example, an intended purpose of the message and/or the intended communication medium. In some examples, the prompt template used in connection with FIG. 8 may differ from the prompt template used in connection with FIGS. 2 and/or 3. For example, limited customer-identifying information, such as a customer name, may be included in the prompt template of FIG. 8, while customer profile information, such as viewership information, may be omitted. That is, the prompt, when generated, may resemble the first portion 610 of the example prompt 600 of FIG. 6, without the second portion 620 of the prompt 600 of FIG. 6 being present.

The example prompt generator circuitry 140 accesses the aggregated customer data for the selected customer. (Block 840). The example prompt generator circuitry 140 then generates a prompt based on the prompt template and the aggregated customer data. (Block 850). As noted above, the aggregated customer data in this example may be limited (or omitted entire). Such customer data may be omitted in this example to accommodate a limited context window of the LLM circuitry 155. That is, some LLM circuitries have limitations related to prompt length. In some examples, LLM circuitries charge users based on the number of tokens included in a prompt. Thus, utilizing longer prompts can lead to increased compute resource utilization. Conversely, reducing prompt size, and/or encoding additional information into an embedding, reduces compute resource utilization. In other words, increasing the amount of information contained in the smallest number of tokens provides immense value in terms of compute resource utilization. To address this issue, examples disclosed herein utilize a Sparse Ordered Random Chops (SpORC) technique.

The example embedding generator circuitry 143 generates an embedding based on the aggregated customer data. (Block 855). The embedding enables aggregated customer data to be encoded more efficiently for use by the LLM circuitry 155. An example approach to generating the embedding is disclosed below in connection with FIG. 9.

The example large language model interface circuitry 150 provides the prompt to the LLM circuitry 155, using the generated embedding as context for generation of a customer message. (Block 860). The example LLM circuitry 155 then generates the customer message and returns the same to the large language model interface circuitry 150.

The example message screener circuitry 160 reviews the message to determine whether the message is acceptable. (Block 870). For example, the message screener circuitry 160 analyzes the message to determine whether the message includes any profanity, any protected customer information (e.g., telephone numbers, personally identifiable information (PII), payment information, etc.) that should not be used when communicating with a customer, or any tokens and/or other variables to be replaced before sending to a customer. If the message is not acceptable (e.g., block 880 returns a result of NO), the message screener circuitry 160 stores an indication of the unacceptable message (e.g., so that the message may be later reviewed by an administrator). (Block 882). If the message is acceptable, the message communicator circuitry 170 causes transmission of the customer message. (Block 886).

The example prompt generator circuitry 140 then determines if there is an additional customer for messaging. (Block 890). If there is an additional customer for messaging (e.g., block 890 returns a result of YES), control proceeds to block 820, where the customer is identified and the message generation process repeats for the identified customer. The example process continues until no further customers are identified for messaging (e.g., until block 890 returns a result of NO). In this manner, customized messages may be generated and transmitted for many different customers. For example, messages may be generated and sent to hundreds, thousands, or even millions of customers, with each of the messages being tailored specifically to the customer to which the message is sent. The example process of FIG. 8 then terminates, but may be repeated periodically (e.g., every week, every month, etc.) and/or a-periodically (e.g., at the request of an administrator).

FIG. 9 is a flowchart representative of example machine readable instructions and/or example operations that may be executed, instantiated, and/or performed by example programmable circuitry to implement the customer messaging platform of FIG. 1 to generate an embedding for use during creation of a customized message for a customer. As noted above in connection with block 855, an embedding that encodes aggregated customer information is utilized. Encoding such information in as small as possible of a format is computationally advantageous. The example approach of FIG. 9 operates on data present in the example aggregated customer data datastore 125 which, in some examples, may include many (e.g., hundreds, thousands, etc.) of fields.

Many databases contain sparsely populated fields where a row might only contain non-null values for a small subset of columns. Just as it is wasteful to encode those columns as dense vectors, it would be similarly wasteful to spend tokens encoding many columns with null values. To address this, the example process 855 of FIG. 9, begins when the embedding generator circuitry 143 removes null customer data fields from the aggregated customer data. (Block 910). In examples disclosed herein, both null and semantic null values may be removed. For example, a column with a null value may be removed. Likewise, a column with a value of a zero character string may be removed. For example, a JavaScript Object Notation (JSON) representation of such columns which are input as “{column_name1: value1, column_name2: NULL, column_nameN:”}” may result in a reduced representation of “{column_name1: value1}”.

After removing null and/or empty data fields, the example embedding generator circuitry 143 sorts the remaining customer data fields by importance. (Block 920). In examples disclosed herein, a defined ordering of importance of fields is stored in the aggregated customer data datastore 125. Such ordering may be generated by business domain experts. In examples disclosed herein, the ordering does not consider sparsity (e.g., null or blank columns that are removed). As a result of the sorting, customer data fields are ordered such that more important fields can be treated differently in subsequent blocks.

The example embedding generator circuitry 143 splits the sorted customer fields into two groups, a first group and a second group. The first group includes a first number of columns from the sorted customer data fields (e.g., the customer data fields having the highest importance). The second group includes the remaining columns from the sorted customer data fields (e.g., the customer data fields having lower importance than the columns included in the first group). Consider, for example, a database having one hundred columns (after removal of null columns). In such an example, the first group may include the first twenty columns, and the second group includes the remaining eighty columns.

The example embedding generator circuitry 143 creates a reduced second group based on the second group of columns. (Block 940). The example reduced second group includes a number of columns randomly sampled from the second group. For example, thirty of the eighty columns may be randomly and/or pseudo-randomly included in the second reduced group.

Using the first group and the reduced group, the example embedding generator circuitry 143 generates an embedding. (Block 950). The embedding is a numerical representation of the values of the selected columns. In this manner, the embedding is based on the number of columns included in the first group and the number of columns included in the reduced second group. Following the example above, the embedding is based on fifty columns, instead of the one hundred columns initially included in the aggregated customer data. However, any number(s) of columns and/or size of embedding may additionally or alternatively be used.

In this manner, the embedding only represents information from fifty columns of customer data (e.g., the columns of the first group and the columns in the reduced second group). As is noted below, aggregating multiple embeddings enables the aggregated embedding to better represent all of the columns, while retaining a smaller embedding size. The example embedding generator circuitry 143 determines whether to generate additional embeddings. (Block 960). In some examples, a threshold number of embeddings is to be generated (e.g., five embeddings). However, any other approach to determining whether additional embeddings are to be generated may additionally or alternatively be used. If additional embeddings are to be generated (e.g., block 960 returns a result of YES), control returns to block 940, where a new reduced second group is created. This new reduced second group will likely include different columns than the reduced second group created in prior iterations of block 940.

After determining that no additional embeddings are to be generated (e.g., block 960 returning a result of NO), the example embedding generator circuitry 143 aggregates the generated embeddings. (Block 970). Because the embeddings are formatted as mathematical vectors, they can be combined in a format that retains the same vector structure. In examples disclosed herein, the embeddings are aggregated using averaging, maximums across the dimensions, and minimums across the dimensions. For example, an average of all of the vectors (embeddings) is added to the maximum vector and the minimum vector to produce an aggregated embedding. However, any other approach to combining multiple embeddings may additionally or alternatively be used including, for example, averaging, a median, standard deviation, etc.

The resulting embedding is returned (block 980), and may be used for a variety of purposes including but not limited to generating personalized prompts and context for an LLM. As noted above in connection with FIG. 8, the embedding is used as a context for the generation of a customer message, thereby enabling a large number of columns (e.g., 100 columns) to be mathematically encoded for use by the LLM circuitry 155, instead of having to provide such information in the prompt text itself. Such an approach reduces the number of tokens needed to generate the customer message, thereby improving resource efficiency in generation of the customer message.

FIG. 10 is a block diagram of an example programmable circuitry platform 1000 structured to execute and/or instantiate the example machine-readable instructions and/or the example operations of FIGS. 2 and/or 3 to implement the customer messaging platform 110 of FIG. 1. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, DSPs, and/or microcontrollers from any desired family or manufacturer. The programmable circuitry 1012 may be implemented by one or more semiconductor based (e.g., silicon based) devices. In this example, the programmable circuitry 1012 implements the example customer messaging platform 110.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1032, which may be implemented by the machine readable instructions of FIGS. 2 and/or 3, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 2 and/or 3 to effectively instantiate the circuitry of FIG. 2 as logic circuits to perform operations corresponding to those machine readable instructions. In some such examples, the circuitry of FIG. 1 is instantiated by the hardware circuits of the microprocessor 1100 in combination with the machine-readable instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 2 and/or 3.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry 1012 of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine readable instructions represented by the flowchart(s) of FIGS. 2 and/or 3 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 2 and/or 3. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 2 and/or 3. As such, the FPGA circuitry 1200 may be configured and/or structured to effectively instantiate some or all of the operations/functions corresponding to the machine readable instructions of the flowchart(s) of FIGS. 2 and/or 3 as dedicated logic circuits to perform the operations/functions corresponding to those software instructions in a dedicated manner analogous to an ASIC. Therefore, the FPGA circuitry 1200 may perform the operations/functions corresponding to the some or all of the machine readable instructions of FIGS. 2 and/or 3 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine readable instructions of FIGS. 2 and/or 3 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 9 and 10 illustrate two example implementations of the programmable circuitry 1012 of FIG. 10, many other approaches are contemplated. For example, FPGA circuitry may include an on-board CPU, such as one or more of the example CPU 1220 of FIG. 11. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine readable instructions represented by the flowchart(s) of FIGS. 2 and/or 3 to perform first operation(s)/function(s), the FPGA circuitry 1200 of FIG. 12 may be configured and/or structured to perform second operation(s)/function(s) corresponding to a second portion of the machine readable instructions represented by the flowcharts of FIGS. 2 and/or 3, and/or an ASIC may be configured and/or structured to perform third operation(s)/function(s) corresponding to a third portion of the machine readable instructions represented by the flowcharts of FIGS. 2 and/or 3.

It should be understood that some or all of the circuitry of FIG. 1 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 1100 of FIG. 11 may execute machine readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIG. 1 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10, which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

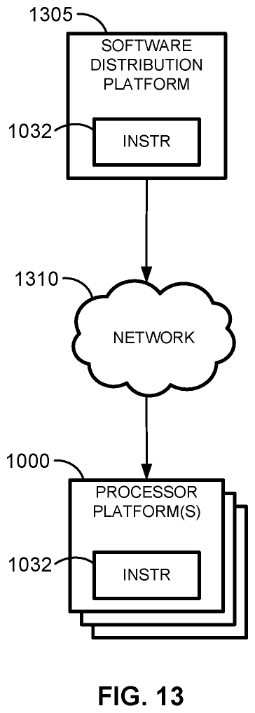

A block diagram illustrating an example software distribution platform 1305 to distribute software such as the example machine readable instructions 1032 of FIG. 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 1032, which may correspond to the example machine readable instructions of FIGS. 2 and/or 3, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1305. For example, the software, which may correspond to the example machine readable instructions of FIGS. 2 and/or 3, may be downloaded to the example programmable circuitry platform 800, which is to execute the machine readable instructions 832 to implement the customer messaging platform 110. In some examples, one or more servers of the software distribution platform 1305 periodically offer, transmit, and/or force updates to the software (e.g., the example machine readable instructions 832 of FIG. 10) to ensure improvements, patches, updates, etc., are distributed and applied to the software at the end user devices. Although referred to as software above, the distributed “software” could alternatively be firmware.

Example methods, apparatus, systems, and articles of manufacture to generate customized customer messages are disclosed herein. Further examples and combinations thereof include the following:

Example 1 includes a non-transitory machine-readable storage medium comprising instructions that, when executed or instantiated by programmable circuitry, facilitate performance of operations, comprising select a prompt template based on an intended purpose of a customized customer message and a type of communication of the customized customer message, generate a prompt based on the prompt template, provide the prompt to a large language model to cause generation of the customized customer message, and cause transmission of the customized customer message.

Example 2 includes the non-transitory machine-readable medium of example 1, wherein the generated prompt includes customer data.

Example 3 includes the non-transitory machine-readable medium of example 2, wherein the customer data is representative of a plurality of customers.

Example 4 includes the non-transitory machine-readable medium of example 1, wherein the operations further comprise generating an embedding based on customer data, the embedding provided to the large language model as a context for the prompt.

Example 5 includes the non-transitory machine-readable medium of example 4, wherein the operations further comprise accessing a plurality of fields of customer data, removing fields having null or empty data from the plurality of columns, sorting the remaining fields, separating the sorted fields into a first group of fields and a second group of fields, and computing the embedding based on the first group of fields and randomly selected fields from the second group of fields.

Example 6 includes the non-transitory machine-readable medium of example 5, wherein the embedding is a first embedding and the randomly selected fields are first randomly selected fields, and the operations further comprise generating a second embedding based on the first group of fields and second randomly selected fields from the second group of fields, and aggregating the first embedding and the second embedding to create an aggregated embedding, the aggregated embedding used as the context for the prompt.

Example 7 includes the non-transitory machine-readable medium of example 1, wherein the operations comprise analyzing the customized customer message to confirm that the customized customer message is acceptable for transmission, wherein the transmission of the customized customer message is to occur after the confirmation that the customized customer message is acceptable for transmission.

Example 8 includes the non-transitory machine-readable medium of example 1, wherein the prompt template is formatted as a structured query language query, and the execution of the structured query language query results in the generation of the prompt.

Example 9 includes a system comprising programmable circuitry, a memory that stores executable instructions that, when executed or instantiated by the programmable circuitry, facilitate performance of operations including select a prompt template based on an intended purpose of a customized customer message and a type of communication of the customized customer message, generate a prompt based on the prompt template, provide the prompt to a large language model to cause generation of the customized customer message, and cause transmission of the customized customer message.

Example 10 includes the system of example 9, wherein the generated prompt includes customer data.

Example 11 includes the system of example 10, wherein the customer data is representative of a plurality of customers.

Example 12 includes the system of example 9, wherein one or more of the at least one processor circuit is to cause one or more of the at least one processor circuit to generate an embedding based on customer data, the embedding provided to the large language model as a context for the prompt.

Example 13 includes the system of example 12, wherein the operations further comprise accessing a plurality of attributes of customer data, removing attributes having null or empty data from the plurality of attributes, sorting the remaining attributes, separating the sorted attributes into a first group of attributes and a second group of attributes, and computing the embedding based on the first group of attributes and randomly selected attributes from the second group of attributes.

Example 14 includes the system of example 13, wherein the operations further comprise generating a second embedding based on the first group of attributes and second randomly selected attributes from the second group of attributes, and aggregating the first embedding and the second embedding to create an aggregated embedding, the aggregated embedding used as the context for the prompt.

Example 15 includes the system of example 9, wherein the operations further comprise analyzing the customized customer message to confirm that the customized customer message is acceptable for transmission, wherein the transmission of the customized customer message is to occur after the confirmation that the customized customer message is acceptable for transmission.

Example 16 includes the system of example 9, wherein the prompt template is formatted as a structured query language query, and the execution of the structured query language query results in the generation of the prompt.

Example 17 includes a method for generating a customized customer message, the method comprising selecting a prompt template based on an intended purpose of the customized customer message and a type of communication of the customized customer message, generating a prompt based on the prompt template, providing the prompt to a large language model to cause generation of the customized customer message, and causing transmission of the customized customer message.

Example 18 includes the method of example 17, wherein the prompt includes customer data.

Example 19 includes the method of example 18, wherein the customer data is representative of a plurality of customers.

Example 20 includes the method of example 17, further including generating an embedding based on customer data, the embedding provided to the large language model as a context for the prompt.

Example 21 includes the method of example 17, further including accessing a plurality of attributes of customer data, removing attributes having null or empty data from the plurality of attributes, sorting the remaining attributes, separating the sorted attributes into a first group of attributes and a second group of attributes, and computing the embedding based on the first group of attributes and randomly selected attributes from the second group of attributes.

Example 22 includes the method of example 21, further including generating a second embedding based on the first group of attributes and second randomly selected attributes from the second group of attributes, and aggregating the first embedding and the second embedding to create an aggregated embedding, the aggregated embedding used as the context for the prompt.

Example 23 includes the method of example 17, further including analyzing the customized customer message to confirm that the customized customer message is acceptable for transmission, wherein the transmission of the customized customer message is to occur after the confirmation that the customized customer message is acceptable for transmission.

Example 24 includes the method of example 17, wherein the prompt template is formatted as a structured query language query, and the execution of the structured query language query results in the generation of the prompt.

From the foregoing, it will be appreciated that example systems, apparatus, articles of manufacture, and methods have been disclosed that enable generation of messages customized to many different customers. In this manner, examples disclosed herein provide computer functionality that was not previously available. In some examples, disclosed systems, apparatus, articles of manufacture, and methods improve the efficiency of using a computing device by grouping customers together into groups, and using information about those groups to cause generation of customized messages at a group level. Generating messages at a group level reduces computational burden as compared to generating messages at an individual level, thereby reducing computational load and freeing resources to perform other computing tasks. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A non-transitory machine-readable storage medium comprising instructions that, when executed or instantiated by programmable circuitry, facilitate performance of operations, comprising:
select a prompt template based on an intended purpose of a customized customer message and a type of communication of the customized customer message;
generate a prompt based on the prompt template;
provide the prompt to a large language model to cause generation of the customized customer message; and
cause transmission of the customized customer message.

2. The non-transitory machine-readable medium of claim 1, wherein the generated prompt includes customer data.

3. The non-transitory machine-readable medium of claim 2, wherein the customer data is representative of a plurality of customers.

4. The non-transitory machine-readable medium of claim 1, wherein the operations further comprise generating an embedding based on customer data, the embedding provided to the large language model as a context for the prompt.

5. The non-transitory machine-readable medium of claim 4, wherein the operations further comprise:
accessing a plurality of fields of customer data;
removing fields having null or empty data from the plurality of columns;
sorting the remaining fields;
separating the sorted fields into a first group of fields and a second group of fields; and
computing the embedding based on the first group of fields and randomly selected fields from the second group of fields.

6. The non-transitory machine-readable medium of claim 5, wherein the embedding is a first embedding and the randomly selected fields are first randomly selected fields, and the operations further comprise:
generating a second embedding based on the first group of fields and second randomly selected fields from the second group of fields; and
aggregating the first embedding and the second embedding to create an aggregated embedding, the aggregated embedding used as the context for the prompt.

7. The non-transitory machine-readable medium of claim 1, wherein the operations comprise analyzing the customized customer message to confirm that the customized customer message is acceptable for transmission, wherein the transmission of the customized customer message is to occur after the confirmation that the customized customer message is acceptable for transmission.

8. The non-transitory machine-readable medium of claim 1, wherein the prompt template is formatted as a structured query language query, and the execution of the structured query language query results in the generation of the prompt.

9. A system comprising:
programmable circuitry;
a memory that stores executable instructions that, when executed or instantiated by the programmable circuitry, facilitate performance of operations including:
select a prompt template based on an intended purpose of a customized customer message and a type of communication of the customized customer message;
generate a prompt based on the prompt template;
provide the prompt to a large language model to cause generation of the customized customer message; and
cause transmission of the customized customer message.

10. The system of claim 9, wherein the generated prompt includes customer data.

11. The system of claim 10, wherein the customer data is representative of a plurality of customers.

12. The system of claim 9, wherein one or more of the at least one processor circuit is to cause one or more of the at least one processor circuit to generate an embedding based on customer data, the embedding provided to the large language model as a context for the prompt.

13. The system of claim 12, wherein the operations further comprise:
accessing a plurality of attributes of customer data;
removing attributes having null or empty data from the plurality of attributes;
sorting the remaining attributes;
separating the sorted attributes into a first group of attributes and a second group of attributes; and
computing the embedding based on the first group of attributes and randomly selected attributes from the second group of attributes.

14. The system of claim 13, wherein the operations further comprise:
generating a second embedding based on the first group of attributes and second randomly selected attributes from the second group of attributes; and
aggregating the first embedding and the second embedding to create an aggregated embedding, the aggregated embedding used as the context for the prompt.

15. The system of claim 9, wherein the operations further comprise analyzing the customized customer message to confirm that the customized customer message is acceptable for transmission, wherein the transmission of the customized customer message is to occur after the confirmation that the customized customer message is acceptable for transmission.

16. The system of claim 9, wherein the prompt template is formatted as a structured query language query, and the execution of the structured query language query results in the generation of the prompt.

17. A method for generating a customized customer message, the method comprising:
selecting a prompt template based on an intended purpose of the customized customer message and a type of communication of the customized customer message;
generating a prompt based on the prompt template;
providing the prompt to a large language model to cause generation of the customized customer message; and
causing transmission of the customized customer message.

18. The method of claim 17, wherein the prompt includes customer data.

19. The method of claim 18, wherein the customer data is representative of a plurality of customers.

20. The method of claim 17, further including generating an embedding based on customer data, the embedding provided to the large language model as a context for the prompt.
